(19) United States
(12) Patent Application Publication
(10) Pub. No.: US 2015/0175264 A1
(43) Pub. Date: Jun. 25, 2015

(54) SOUND PROTECTION DEVICE FOR SEPARATING OFF A SPACE IN AN AIRCRAFT

(71) Applicant: DIEHL AIRCABIN GMBH, Laupheim (DE)

(72) Inventors: Reinhold BURR, Heidenheim (DE); Klaus BOOCK, Timmdorf, Malente (DE); Emanuel HABERSTOCK, Bernstadt (DE)

(73) Assignee: DIEHL AIRCABIN GMBH, Laupheim (DE)

(21) Appl. No.: 14/575,161

(22) Filed: Dec. 18, 2014

(30) Foreign Application Priority Data
Dec. 21, 2013 (DE) 102013021847.0

(51) Int. Cl. B64D 11/00

(52) U.S. Cl. CPC B64D 11/00

(57) ABSTRACT

The invention relates to a sound-attenuating device for separating off spaces in an aircraft, wherein the device (11) has a screening element (1) which is connected to a supporting means (4) such that it can be moved from a closed state to an open state, and which is designed to at least partially close an opening (12), wherein the screening element (1) comprises a first layer (6) having a sound-reflecting characteristic and a compressible second layer (7) having a sound-absorbing characteristic, which layers are arranged between a first cover layer (8) and a second cover layer (9), wherein the first layer (6), the second layer (7), the first cover layer (8) and the second cover layer (9) are stitched so as to form longitudinal seams (2), along which the screening element (1) can be folded.

### FIELD OF THE INVENTION

The invention relates to a sound protection device, i.e. a sound-protecting device designed for separating off a cabin space in an aircraft.

### BACKGROUND OF THE INVENTION

In modern aircraft cabins, efforts are increasingly being made to offer passengers the highest possible level of comfort. To that end, spaces which are spatially separated from one another are provided for passengers. These can on one hand be sections of the aircraft cabin, in which rows of seats for passengers are arranged. On the other hand, sleeping areas—which may be used by passengers but also by members of the crew—are also provided in aircraft cabins. These spaces are provided by means of a partitioning device, for example a curtain, which is closed, in particular during the night time on medium- and long-haul flights, such that the passengers are exposed to as little disruptive noise as possible. However, due to safety regulations, curtains must be open during takeoff and landing. Conventionally, in order to be opened, curtains are folded or pushed together and are then held or attached by a suitable mechanism at their longitudinal sides.

DE 25 26 025 A1 discloses a device for forming drapes on a curtain, which is secured on the rear side of a curtain close to the upper curtain edge. The device has, in alternation, rigid regions and a drape of the curtain perpendicular to the upper curtain edge in drape regions. To that end, there are provided a multiplicity of rigid plates and means for securing, to the upper curtain edge, the plates which provide the rigid regions at regular mutual intervals, wherein the drape regions are between the plates and run perpendicular to the upper curtain edge.

For reasons of increased comfort for passengers, disruptive noise is to be avoided as much as possible during night-time flight periods. However, the above-described devices are not optimized with respect to their sound attenuation, such that, in particular when passenger cabins in airliners are initially fitted or are retrofitted, no improvement would result.

### SUMMARY OF THE INVENTION

It is thus an object of the invention to provide a sound-attenuating device for separating off a space in an aircraft, which device overcomes the disadvantages mentioned in the introduction and is simple to install in an aircraft or, where relevant, to retrofit in existing aircraft cabins, such that improved sound attenuation results.

This object is achieved with the features of Claim 1. Further advantageous configurations of the invention form the subject matter of the respective subclaims. These may be combined with one another in a technologically meaningful manner. The description, in particular with reference to the drawing, additionally characterizes and clarifies the invention.

The invention proposes a sound protection device, in particular a sound-attenuating, sound-absorbing and/or sound-damping device for separating off spaces in an aircraft. The device comprises a screening element which can be connected to a supporting means such that it can be moved from a closed state, in particular a folded-together and/or pushed-together state, to an open state, in particular an unfolded and/or spread-out state, and is designed to at least partially close and/or cover a given opening, in particular of predefined size.

The screening element has a first layer having a sound-reflecting characteristic, and also a second layer having, at least in certain sections or segments, a sound-absorbing, sound-attenuating and/or sound-damping characteristic.

The first layer and the second layer are arranged between a first cover layer and a second cover layer. The first layer, the second layer, the first cover layer and the second cover layer are stitched or provided with a seam and connected to one another by means of the seam so as to form, on the screening element, longitudinal seams along which the screening element can be folded, i.e. in particular so as to form folding creases formed by the longitudinal seams on the screening element, at which creases the screening element can be folded with respect to the adjoining segments, in particular pushed together or laid together into longitudinal folds. In that context, the longitudinal seams serve as folding axes when folding the screening element.

Accordingly, multiple layers are stitched together in order to form a screening means. In that context, the layered construction comprises a first layer having a sound-reflecting characteristic and a compressible second layer having a sound-absorbing characteristic, which layers improve the attenuation and damping properties on account of their characteristics with respect to sound sources, such that the desired sound attenuation, sound absorption and/or sound damping can be achieved. Moreover, the screening means can be folded, such that the fold edges or fold axes form along the longitudinal seams, or the longitudinal seams are formed such that they form the fold edges or the fold axes for folding.

The absorbent second layer may in particular be compressible and/or elastically deformable.

In the context of the invention, it is in particular possible that the absorbent second layer has a sound-absorbing characteristic, or the desired sound-absorbing characteristic, only in certain section or segments. This can for example mean that the full sound-absorbing characteristic exists only outside the longitudinal seams, and in the region of the longitudinal seams there is less or no effective sound-absorbing characteristic.

According to other variants, it is possible for the second layer to be impressed and/or pre-imprinted and/or compressed in the regions of reduced sound-absorbing characteristic, i.e. of reduced sound protection properties, in particular in the region of and, where relevant, adjacent to the respective longitudinal seam.

According to other variants, it is possible for the second layer to be arranged on the airtight first layer only in certain sections. For example, the second layer can be applied to the first layer in segments and/or in strips, in particular in multiple strips running parallel to the longitudinal seams. In gaps between adjacent parallel strips, where no material of the second layer is applied, it is possible for in each case one longitudinal seam to be provided or created. The longitudinal seam region may thus be produced with a lesser thickness and, where relevant, improved flexibility in comparison with in each case adjacent regions having a first and a second layer, which in turn is advantageous for folding the screening element together.

In other configurations and variants, the composite construction, formed from the cover layer(s) and the first and second layers, may be stitched by means of or using additional seams, in particular quilting seams. The additional seams may in particular be arranged and formed such that a respectively required sound damping is achieved. It has been recognised according to the invention that such additional seams offer the possibility of changing, in a targeted manner, at least the sound-damping properties of the screening element, in particular of the composite construction.

It is also possible, within the context of the invention, to provide a sound protection device for separating off spaces in an aircraft, which device has a screening element which is connected to a supporting means such that it can be moved from a closed state to an open state, and which is designed to at least partially close an opening, wherein the screening element comprises a first layer having a sound-reflecting characteristic and a second layer having, at least in certain sections, a sound-absorbing characteristic, wherein a cover layer is applied to the first and/or the second layer, and the composite construction formed from cover layer(s), first layer and second layer is stitched by means of longitudinal seams such that the screening element can be folded and the longitudinal seams form the fold edges and/or the fold axes.

According to one embodiment of the invention, the first layer is a silicone layer. The first layer may in general be a layer of a material which is permitted in the field of aeronautics.

A silicone layer used in the construction of the proposed device may in particular contribute to improving the sound-reflecting characteristics. For reasons of advantageous sound protection properties, it is in particular possible to use thinner first layers. In particular, the latter may, in the case of advantageous sound protection properties, lead to a reduction in weight in comparison with conventional systems. In particular, it is possible to provide a screening means which, in addition to having an advantageous sound protection characteristic, is also comparatively lightweight.

According to another embodiment of the invention, the second layer is a sound-absorbing and/or sound-attenuating material. Such a material may in particular comprise a needle felt, a fleece material and/or an open-cell foam, or be made from such materials.

This configuration also permits, in addition to the desired sound protection characteristic, and in particular the desired sound-absorbing, sound-damping and/or sound-attenuating characteristic, the provision of a compressible material. In particular, a compressible material allows the two or at least two layers to be stitched. Accordingly, the second layer may be compressed, such that a fold edge may be produced.

According to another embodiment of the invention, the first cover layer and the second cover layer are made from a textile fabric, a textile knit and/or a textile assembly. The use of such materials and of the respective internal structures enables comparatively broad variation of the sound protection properties, in particular according to the respective requirement profile.

According to another embodiment of the invention, a pelmet is formed in the region of the supporting means, on a front side of the screening element which is arranged in the direction of a possible sound source, at a distance from the supporting means, such that this pelmet can cover a gap arranged between the screening element and the supporting means.

An arrangement of this type, with a gap, is also common in conventional curtains, such that the aircraft cabin can be ventilated in the event of a fire, and is also often prescribed by law. The invention can thus be relatively simply retro-fitted into existing aircraft cabins without having to undertake conversion work. A pelmet reduces any sound which might pass through the gap. The pelmet may be produced from the same layer sequence as the screening element, but alternative layer sequences are also possible for the pelmet.

According to another embodiment of the invention, a further pelmet is formed in the region of the supporting means, on the opposite side of the screening element from possible sound sources.

Covering the gap on this side too leads to a further improvement in the noise level, wherein the further pelmet may be also produced from the same layer sequence as the screening element. The further pelmet may be attached in addition to or as an alternative to the above-described pelmet.

The pelmets may be formed asymmetrically, in terms of material and/or in terms of shape, with respect to the screening element. For example, the pelmet on the side facing the sound may form an airtight barrier, for example by selecting a corresponding airtight material such as silicone. On the side facing away from the sound, the corresponding pelmet may form an absorbent barrier, for example by selecting a corresponding absorbent material such as a porous, woven or similar material.

According to another embodiment of the invention, the longitudinal seams are stitched such that the compressible second layer is compressed in the region of the longitudinal seams.

Compressing the second layer allows the screening element to be folded, for example when the aircraft is taking off or landing. One property of the materials used is that the screening element is relatively rigid, such that it would be difficult to push together. By virtue of the fold edges provided, the screening element can be opened relatively easily.

According to another embodiment of the invention, the screening element can be folded in a zigzag shape.

A zigzag shape allows simple closing and opening of the screening element and ensures simple and thus intuitive operability. Moreover, a zigzag shape can be integrated without any great space requirement, which in turn simplifies the retrofitting of existing aircraft cabins.

Also indicated is an aircraft cabin which is equipped with a sound-attenuating device as described above.

Also indicated is an aircraft cabin in which the sound-attenuating device separates off a cabin space or a berth.

The individual features may of course also be combined with one another, which may also result in part in advantageous effects which are greater than the sum of the individual effects.

### BRIEF DESCRIPTION OF THE DRAWINGS

In the following, some exemplary embodiments will be described in more detail with reference to the drawings, in which:

FIG. 1 shows a side view of a screening element for a sound-attenuating device according to the invention,

FIG. 2 shows a cross-sectional view of the screening element for a sound-attenuating device according to the invention from FIG. 1,

FIG. 3 shows a side view of a sound-attenuating device according to one embodiment of the invention,

FIG. 4 shows a further side view of a sound-attenuating device according to one embodiment of the invention, and

FIG. 5 shows a cross-sectional view of the sound-attenuating device according to FIG. 3 or FIG. 4.

### DETAILED DESCRIPTION OF EXEMPLARY EMBODIMENTS

In the figures, identical or functionally identical components are provided with the same reference sign.

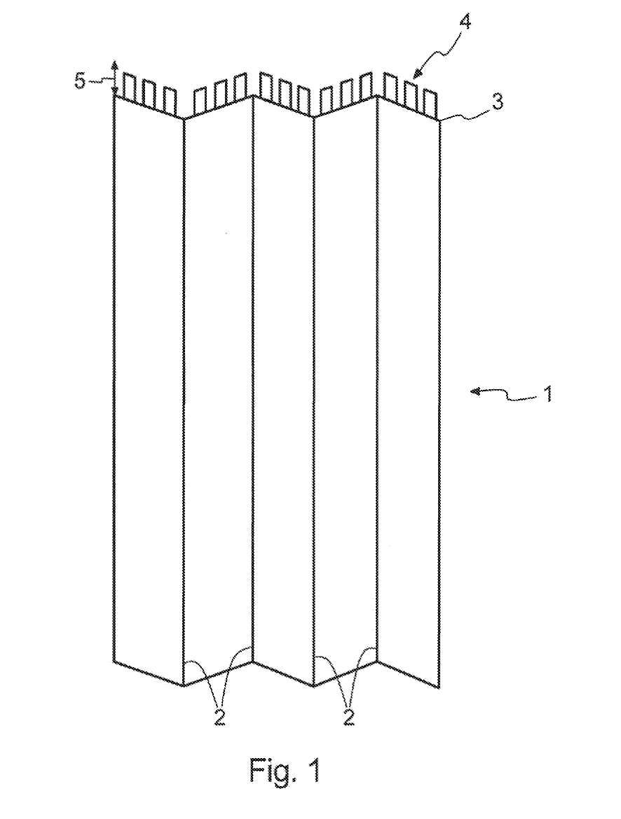

One embodiment of the invention will be described in more detail below, with reference to FIG. 1.

FIG. 1 shows a screening element 1 for a sound-attenuating device which for example delimits individual spaces in an aircraft cabin or a berth. An aircraft commonly has a multiplicity of these screening elements 1 which, for example, are arranged adjacent to one another in order to provide a predetermined number of sleeping places.

In FIG. 1, the screening element 1 is shown in a closed or almost closed state. The screening element 1 has multiple longitudinal seams 2. The longitudinal seams 2 serve as fold edges for opening the screening element 1. The screening element 1 has, at its upper end 3, part of a supporting means 4 which engages in corresponding further parts of the supporting means on a cabin ceiling or a cabin wall, in order to support movement from the closed to the open state. The supporting means 4 may for example be sliders which are inserted into a rail, as is common in the art when curtains are provided. Other supporting means 4 familiar to a person skilled in the art are of course not excluded. At the upper edge, the part of the supporting means on the screening element 1 defines a gap 5, as indicated in FIG. 1. This gap 5 may for example be prescribed by law, in order to allow air to circulate.

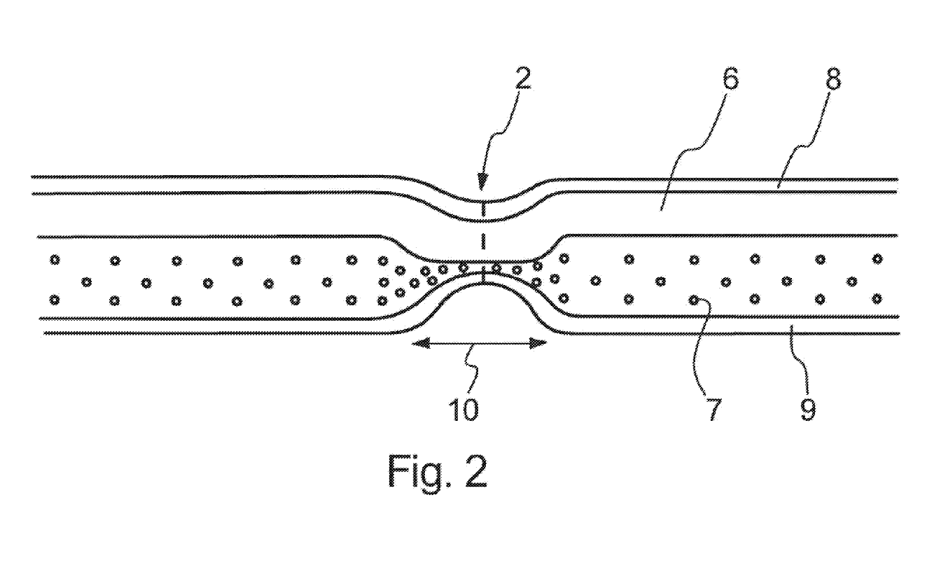

The construction of the screening element 1 is shown in FIG. 2. FIG. 2 shows a cross-sectional view of the screening element 1. The screening element 1 has a first layer 6 having a sound-reflecting characteristic. The first layer 6 is for example a silicone layer. The thickness of the silicone layer is, for example, 1.2 mm.

Furthermore, the screening element 1 has a compressible second layer 7 having a sound-absorbing characteristic. The second layer 7 is for example made from a needle felt, a fleece material or an open-cell foam. The thickness of the second layer 7 is, for example, 4 mm.

The first layer 6 and the second layer 7 are arranged between a first cover layer 8 and a second cover layer 9. The first cover layer 8 and the second cover layer 9 are made from a textile fabric. This configuration ensures an appealing visual appearance, as is known for example from textile curtains.

As shown in FIG. 2, the first layer 6, the second layer 7, the first cover layer 8 and the second cover layer 9 are stitched so as to form the longitudinal seams 2, along which the screening element 1 can be folded. In that context, the longitudinal seams 2 are stitched such that the compressible second layer 7 is compressed in the region 10 of the longitudinal seams 2. Accordingly, the screening element 1 can be folded in a zigzag shape.

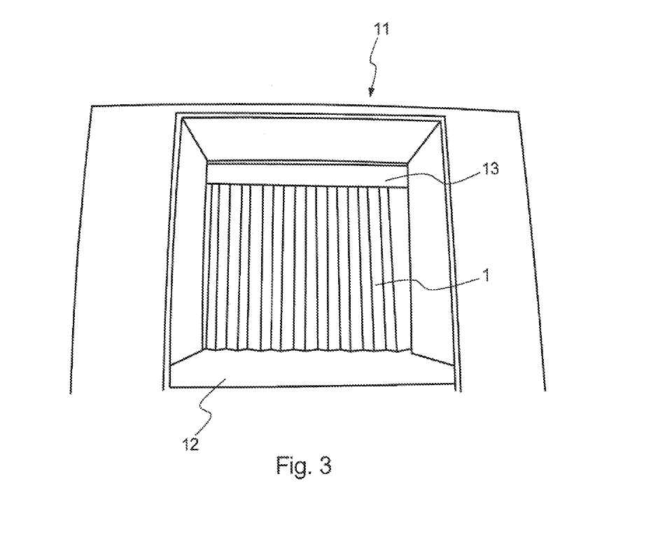

FIG. 3 shows an example of a sound-attenuating device 11 having a screening element 1 as shown in FIGS. 1 and 2. In the sound-attenuating device 11 shown, the screening element 1 covers an opening 12 which is for example intended to bound a sleeping place for an air passenger. In this representation, potential sound sources are arranged in front of the screening element 1, such that the space which is separated off by the screening element 1 is substantially quieter than in the prior art, in order to provide the passengers with greater comfort. In order to at least partially close the gap 5, the sound-attenuating device 11 has a pelmet 13 which is of the same construction as the screening element 1.

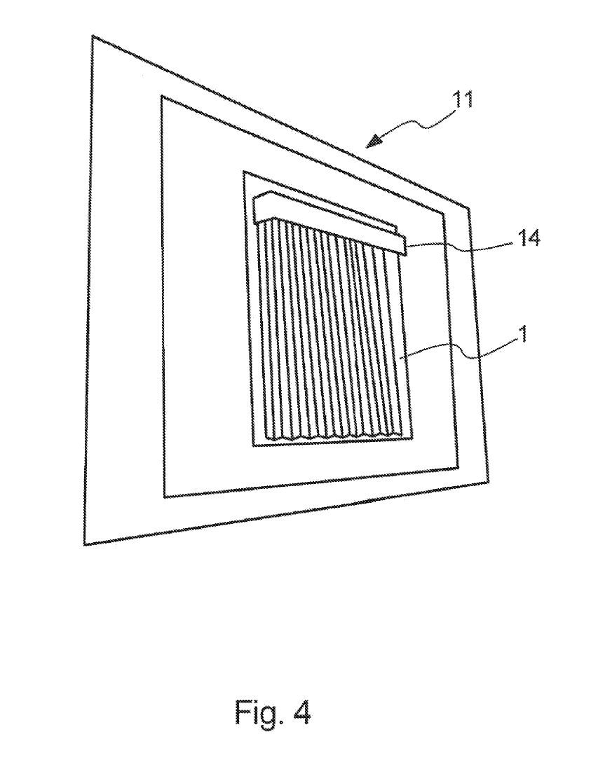

FIG. 4 shows the sound protection device, in particular the sound-attenuating, sound-absorbing and/or sound-damping device 11 from an opposite viewpoint, i.e. from the space separated off in FIG. 3. In order to at least partially close the gap 5 from this side too, the sound-attenuating device 11 has a further pelmet 14 which is also of the same construction as the screening element 1. The pelmet 13 can cover the gap 5 in a range between 5 cm and 15 cm.

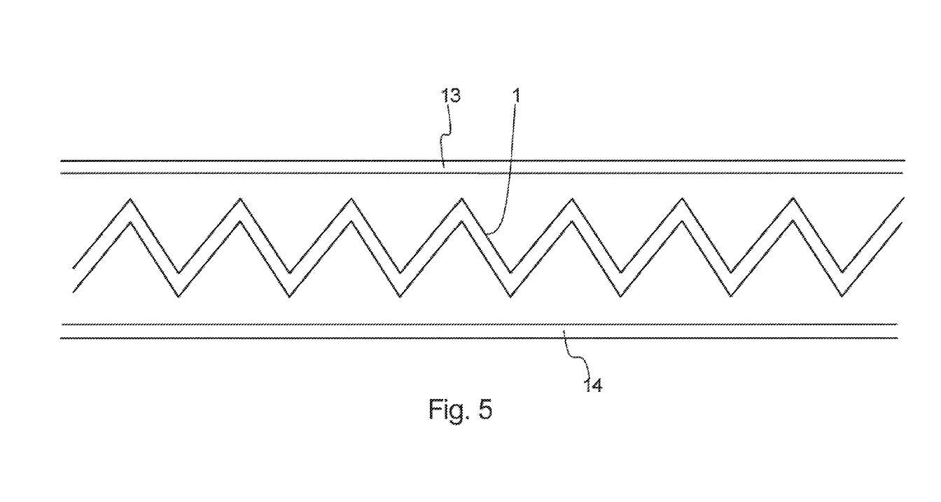

FIG. 5 shows a cross-sectional view of the sound-attenuating device 11 from FIG. 3 and FIG. 4 along a line running just below the upper end 3. The screening element 1 is installed between the pelmet 13 and the further pelmet 14. The further pelmet 14 can also cover the gap 5 in a range between 5 cm and 15 cm.

It is to be noted that the term “comprises” does not exclude further elements or method steps, just as the term “one” does not exclude further elements and steps.

The reference signs used serve merely to improve comprehensibility and should in no way be considered to be limiting, the scope of protection of the invention being reproduced by the claims.

### LIST OF REFERENCE SIGNS

1 Screening element
2 Longitudinal seams
3 Upper end
4 Supporting means
5 Gap
6 First layer
7 Second layer
8 First cover layer
9 Second cover layer
10 Region of the longitudinal seams
11 Sound-attenuating device
12 Opening
13 Pelmet
14 Further pelmet

What is claimed is:

1. A sound protection device for separating off spaces in an aircraft, wherein the device has a screening element which is connected to a supporting means such that it can be moved from a closed state to an open state, and which is designed to at least partially close an opening, wherein the screening element comprises a first layer having a sound-reflecting characteristic and a second layer, formed at least in certain sections, having, at least in certain sections, a sound-absorbing characteristic, wherein a cover layer is applied to the first or the second layer, or these are arranged between a first cover layer and a second cover layer, wherein the first layer and the second layer are stitched to the cover layer or to the first cover layer and the second cover layer so as to form longitudinal seams, along which the screening element can be folded.

2. The sound-attenuating device according to claim 1, wherein the first layer is a silicone layer.

3. The sound-attenuating device according to claim 1, wherein the second layer is made from a needle felt, a fleece material or an open-cell foam.

4. The sound-attenuating device according to claim 1, wherein the first cover layer and the second cover layer are made from a textile fabric.

5. The sound-attenuating device according to claim 1, wherein a pelmet is formed in the region of the supporting means, in the direction of a sound source, and covers a gap arranged between the screening element and the supporting means.

6. The sound-attenuating device according to claim 5, wherein a further pelmet is formed in the region of the supporting means, on the opposite side of the screening element from possible sound sources.

7. The sound-attenuating device according claim 1, wherein the longitudinal seams are stitched such that the compressible second layer is compressed in the region of the longitudinal seams.

8. The sound-attenuating device according to claim 1, wherein the screening element can be folded in a zigzag shape.

9. An aircraft cabin having a sound-attenuating device according to claim 1.

10. The aircraft cabin according to claim 9, wherein the sound-attenuating device separates off a cabin space or a berth.
